(19) United States
(12) Patent Application Publication
(10) Pub. No.: US 2019/0158780 A1
(43) Pub. Date: May 23, 2019

(54) IMAGE PROCESSING APPARATUS, CONTROL METHOD THEREFOR, IMAGE DISPLAY APPARATUS, AND COMPUTER READABLE STORAGE MEDIUM

(71) Applicant: CANON KABUSHIKI KAISHA, Tokyo (JP)

(72) Inventor: Ryosuke Mizuno, Tokyo (JP)

(21) Appl. No.: 15/504,921

(22) PCT Filed: Sep. 11, 2015
(86) PCT No.: PCT/JP2015/004633

§ 371 Date: Feb. 17, 2017

(30) Foreign Application Priority Data
Oct. 20, 2014 (JP) 2014-213981

(51) Int. Cl. H04N 7/01; G09G 3/20; H04N 5/205; H04N 5/21

(52) U.S. Cl. CPC H04N 7/0132; G09G 3/2025; H04N 5/205; G09G 2360/12; G09G 2320/10; G09G 2340/0435; H04N 5/21

(57) ABSTRACT

An image processing apparatus includes: input means for inputting a frame image; generation means for generating a plurality of sub-frame images from the frame image input by the input means; image processing means for changing a brightness and spatial frequency component of a first sub-frame image out of the plurality of sub-frame images to be different from a brightness and spatial frequency component of a second sub-frame image out of the plurality of sub-frame images; and output means for outputting the first sub-frame image and the second sub-frame image.

### TECHNICAL FIELD

The present invention relates to an image processing apparatus, a control method therefor, an image display apparatus, and a computer readable storage medium and, more particularly, to a technique for reducing a motion blur in a hold-type display apparatus.

### BACKGROUND ART

Recently, image display apparatuses including various display devices such as a liquid crystal display device, ranging from a TV receiver to a PC monitor, have been put into practical use. When pursuit of a moving object (way of viewing in which a moving object is pursued by the line of sight in a moving image display) is performed in a hold-type display apparatus especially typified by a liquid crystal display apparatus, a motion blur corresponding to the optical output period is observed.

Reducing a motion blur by dividing an input image signal having a frame rate of, for example, 60 Hz into sub-frame images having a double frame rate of 120 Hz, and outputting one sub-frame image as a black image to shorten the optical output period is known. It is also known that the unnaturalness of a motion is reduced by restricting the continuous emission period or effective emission period to at least a range not exceeding 30% to 70% between sub-frames, instead of the black image (Japanese Patent Laid-Open No. 4-302289).

Although the arrangement described in Japanese Patent Laid-Open No. 4-302289 can reduce the unnaturalness of a motion, the luminance may decrease as the ratio of the effective emission period is decreased. If the brightness difference between sub-frames is large, it may be visually recognized as a flicker.

### SUMMARY OF INVENTION

The present invention has been made to solve the above-described problems, and provides a technique capable of suppressing a decrease in luminance and an increase in flicker while reducing the unnaturalness of a motion.

According to one aspect of the present invention, an image processing apparatus includes: input means for inputting a frame image; generation means for generating a plurality of sub-frame images from the frame image input by the input means; image processing means for changing a brightness and spatial frequency component of a first sub-frame image out of the plurality of sub-frame images to be different from a brightness and spatial frequency component of a second sub-frame image out of the plurality of sub-frame images; and output means for outputting the first sub-frame image and the second sub-frame image.

According to another aspect of the present invention, an image display apparatus includes: an image processing apparatus; and display means for displaying a sub-frame image output from an output means, wherein the image processing apparatus comprises: input means for inputting a frame image; generation means for generating a plurality of sub-frame images from the frame image input by the input means; image processing means for changing a brightness and spatial frequency component of a first sub-frame image out of the plurality of sub-frame images to be different from a brightness and spatial frequency component of a second sub-frame image out of the plurality of sub-frame images; and output means for outputting the first sub-frame image and the second sub-frame image.

According to still another aspect of the present invention, a control method for an image processing apparatus, includes: an input step of causing input means to input a frame image; a generation step of causing generation means to generate a plurality of sub-frame images from the frame image input in the input step; an image processing step of causing image processing means to change a brightness and spatial frequency component of a first sub-frame image out of the plurality of sub-frame images to be different from a brightness and spatial frequency component of a second sub-frame image out of the plurality of sub-frame images; and an output step of causing output means to output the first sub-frame image and the second sub-frame image.

According to yet another aspect of the present invention, a non-transitory computer-readable storage medium storing a computer program for causing a computer to function as each means of an image processing apparatus includes: input means for inputting a frame image; generation means for generating a plurality of sub-frame images from the frame image input by the input means; image processing means for changing a brightness and spatial frequency component of a first sub-frame image out of the plurality of sub-frame images to be different from a brightness and spatial frequency component of a second sub-frame image out of the plurality of sub-frame images; and output means for outputting the first sub-frame image and the second sub-frame image.

Further features of the present invention will become apparent from the following description of exemplary embodiments (with reference to the attached drawings).

### BRIEF DESCRIPTION OF DRAWINGS

FIG. 1 is a block diagram showing an example of the functional arrangement of an image display apparatus;

FIG. 2 is a block diagram showing another example of the functional arrangement of the image display apparatus;

FIG. 3 is a flowchart showing the processing procedures of processing to be executed by the image display apparatus;

FIG. 4 is a block diagram showing an example of the functional arrangement of an image display apparatus;

FIG. 5 is a graph showing an example of the parameter setting;

FIG. 6 is a flowchart showing the processing procedures of processing to be executed by the image display apparatus;

FIG. 7 is a block diagram showing an example of the functional arrangement of an image display apparatus; and

FIG. 8 is a flowchart showing the processing procedures of processing to be executed by the image display apparatus.

### DESCRIPTION OF EMBODIMENTS

Embodiments of the present invention will now be described in detail with reference to the accompanying drawings.

An image display apparatus (image processing apparatus) according to an embodiment outputs an image of each frame input frame by frame as two sub-frame images, and outputs the two sub-frame images in order within a one-frame period, thereby obtaining an output frame rate double the input frame rate. When outputting sub-frame images, the sub-frames are displayed with a brightness difference, the spatial high-frequency component of the image is emphasized in the bright image, the spatial high-frequency component of the image is attenuated in the dark image, and these images ae output to reduce a motion blur. In the following description, F[i] ith (i=1, 2, . . . ) is the sub-frame image (image output in the ith turn from the image display apparatus).

### Functional Arrangement of Image Display Apparatus

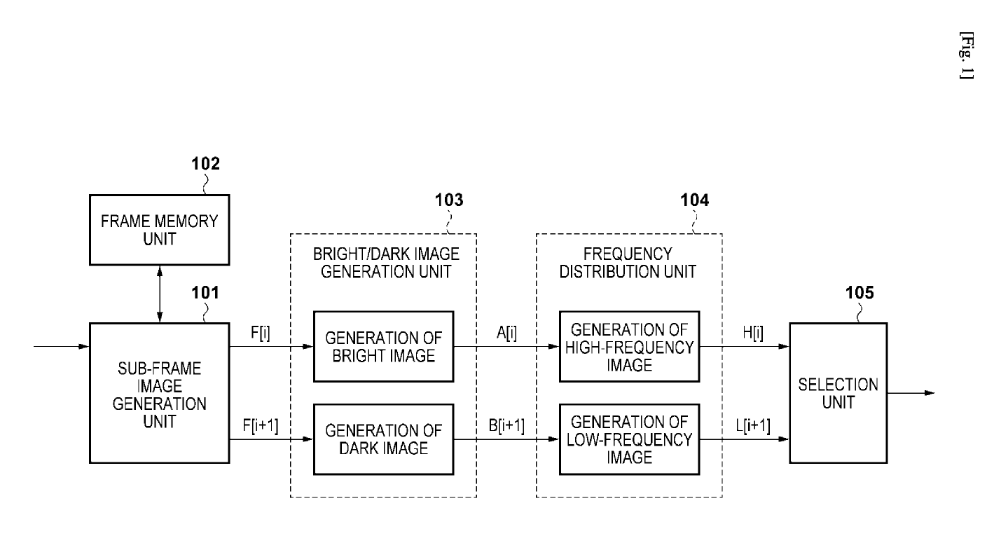

The image display apparatus according to this embodiment will be explained. FIG. 1 is a block diagram showing an example of the functional arrangement of the image display apparatus according to the embodiment of the present invention.

A sub-frame image generation unit 101 stores an image of each input frame in a frame memory unit 102, and reads it out at a frame rate double the input frame rate, thereby generating a first sub-frame image F[i] and a second sub-frame image F[i+1]. Although the first sub-frame image F[i] and the second sub-frame image F[i+1] are the same image in this embodiment, the second sub-frame image may be a frame interpolation image or a frame combination image.

The frame interpolation image is generated by estimating the motion vector of an object from data of a plurality of frames, for example, a target frame and an immediately preceding frame. An example of the frame interpolation image generation method will be explained. First, each of an image of the current frame serving as the reference and an image to be displayed in the next frame is divided at a predetermined block size. A block having a highest correlation is acquired from the image to be displayed in the next frame for each block of the current block, and a motion vector is estimated. In the processing of obtaining a high-correlation block, for example, a block matching algorithm can be used. A frame interpolation image is generated in accordance with the estimated motion vector so that this block is moved to an intermediate position between the frames. The frame combination image is generated by, for example, performing weighted averaging of sub-frame images before and after a target sub-frame to be output.

A bright/dark image generation unit 103 includes a bright image generation unit and a dark image generation unit, and adjusts the brightness of at least part of each subframe image. The bright/dark image generation unit 103 performs brightness adjustment for the first sub-frame image F[i] and the second sub-frame image F[i+1]. For example, the bright/dark image generation unit 103 multiplies each of the R, G, and B levels of an input image by a predetermined ratio (gain value) to adjust the output level. Letting Gα be a gain value for the first sub-frame image F[i], the gain value Gα can be adjusted within a range of about 120% (1.2) to 50% (0.5). In contrast, letting Gβ be a gain value for the second sub-frame image F[i+1], it is desirable that the gain value Gβ can be adjusted within a range of 100% (1.0) to 0% (0.0) and is equal to or smaller than the gain value Gα set for the first sub-frame image F[i]. For example, when the second sub-frame image F[i+1] is a frame interpolation image, if the estimation result of the motion vector is erroneous, this may be a factor that degrades the image quality, but the degradation can be made less noticeable by lowering the output level. Brightness adjustment is not limited to the method of multiplying the R, G, and B levels by gain values, and it is also possible to separate an image into a luminance value Y and color components Cb and Cr and then multiply the luminance value Y by a gain value. Only some signal levels may be multiplied by gain values, or the brightness of each of R, G, and B may be adjusted by a nonlinear characteristic using a lookup table or the like The ranges of possible values of the gain values Gα and Gβ are not limited to the above-described ones. In the following description, A[i] is a bright image output from the bright/dark image generation unit 103, and B[i+1] is a dark image.

A motion blur is visually recognized by pursuing a moving object, and is more readily visually recognized by pursuing a high-frequency portion such as the edge of an object in an image. The motion blur can be suppressed by locally displaying high-frequency components in one sub-frame. A method of suppressing a motion blur by using this principle will be called a spatial frequency separation method. A frequency distribution unit 104 generates a high-frequency image H[i] in which the high-frequency component of an image is emphasized for the bright image A[i], and generates a low-frequency image L[i+1] in which the high-frequency component of the image is attenuated for the dark image B[i+1]. The low-frequency image L[i+1] is generated by performing low-pass filter (LPF) processing on the dark image B[i+1]:

L[i+1]=B[i+1]−(B[i+1]−LPF(B[i+1]))*Fβ (1)

The high-frequency image H[i] is generated by attenuating a low-frequency component based on, for example:

H[i]=A[i]+(A[i]−LPF(A[i]))*Fα (2)

where Fα and Fβ are coefficients for adjusting the degrees of emphasis and attenuation of a high-frequency component, respectively. An example in which Fα=1 and Fβ=1 will be explained here. The low-pass filter is a filter that cuts off a high-frequency component out of spatial frequencies in an image and generates a spatial low-frequency image. The low-pass filter can be constituted as a 16×10 two-dimensional filter, but the function is not particularly limited. For example, the function may be a Gaussian function or can be implemented as a moving average or a weighted moving average. In this embodiment, the high-frequency image H[i] is generated by attenuating the low-frequency component of an image, but a two-dimensional filter that emphasizes a spatial high-frequency component may be arranged independently. In this case, the frequency distribution unit 104 can be functionally divided into a low-frequency image generation unit and a high-frequency image generation unit.

A selection unit 105 alternately outputs H[i] and L[i+1] at a sub-frame rate double the frame rate.

Although the case in which the output frame rate double the input frame rate is obtained has been described above, an arrangement that converts the input frame rate into a three times or more frame rate may be adopted. In general, N (N≥2) sub-frame images may be generated for one frame image to output the sub-frame images at a rate N times higher than the frame rate. In this case, the selection unit 105 may not adopt the alternate output order. It is only necessary to output sub-frames at predetermined timings such that low-frequency images with different filter multipliers are displayed successively twice, or sub-frames include a sub-frame that directly displays an output from the sub-frame image generation unit 101. An image is not limited to a sub-frame, and the emission amount may be limited in a predetermined optical output period, and the upper limit spatial frequency of an image to be displayed in this period may be cut off.

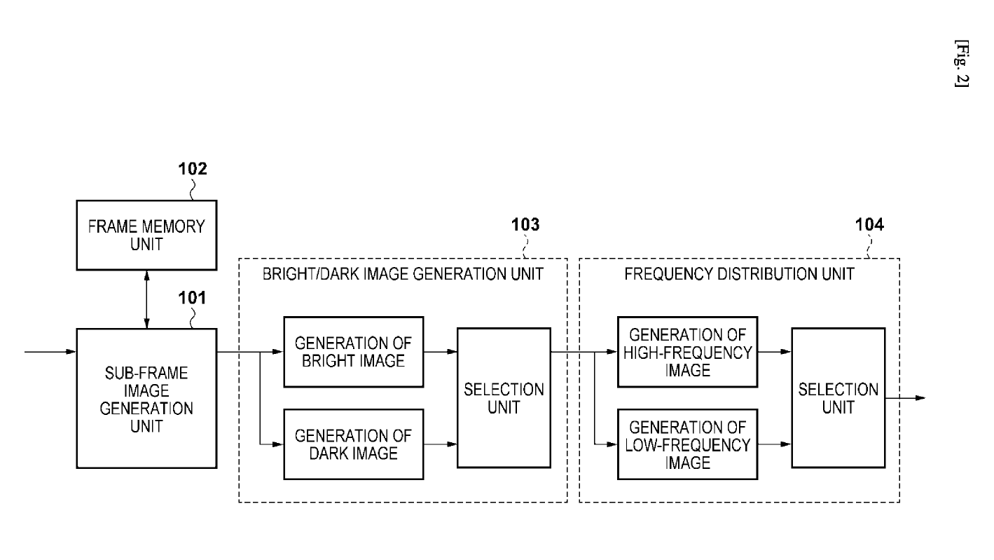

FIG. 2 is a block diagram showing another example of the functional arrangement of the image display apparatus according to this embodiment. In the example of the arrangement of FIG. 2, each of the bright/dark image generation unit 103 and frequency distribution unit 104 includes the selection unit 105. The sub-frame image generation unit 101 stores an input image of each frame in the frame memory unit 102, reads it out at, for example, a frame rate double the input frame rate, and outputs it to the bright/dark image generation unit 103. As described above, the bright/dark image generation unit 103 generates bright and dark images, and selects and outputs either image. As described above, the frequency distribution unit 104 generates a high-frequency image and low-frequency image, and selects and outputs either image. In this case, the frequency distribution unit 104 generates a high-frequency image for a bright image and generates a low-frequency image for a dark image. Even the arrangement shown in FIG. 2 can obtain the same output as that obtained by the arrangement shown in FIG. 1.

Note that the image display apparatus according to this embodiment is implemented by dedicated hardware such as an IC (Integrated Circuit) circuit or an embedded device. As a matter of course, all or some of the functions in FIG. 1 or 2 may be implemented by software. That is, the same functions may be implemented by performing processing by a general-purpose information processing apparatus such as a personal computer (PC) or a tablet terminal based on a computer program. In this case, the processing is executed under the control of a CPU (Central Processing Unit).

### Processing Procedures

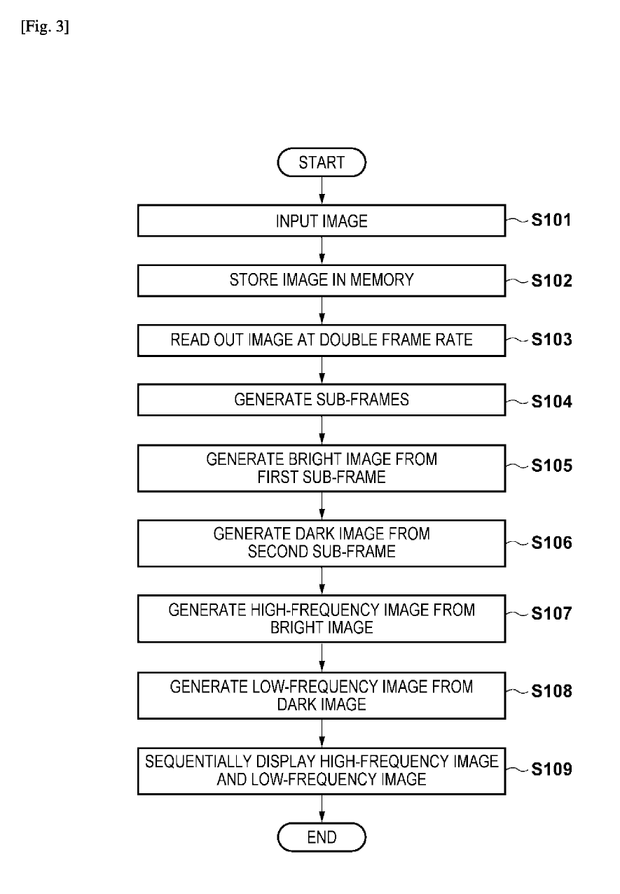

Next, a series of processes to be executed by the image display apparatus according to this embodiment will be explained with reference to FIG. 3. FIG. 3 is a flowchart showing the processing procedures of processing to be executed by the image display apparatus according to this embodiment.

First, the sub-frame image generation unit 101 sequentially receives respective frame images constituting a moving image (step S101), and stores the received frames in the frame memory unit 102 (step S102). The reception and storage of the frame are performed in accordance with the frame rate of the moving image. This processing can be performed at once based on a predetermined cycle for every predetermined number of frames in accordance with the memory capacity of the frame memory unit 102.

Then, the sub-frame image generation unit 101 reads out a frame image from the frame memory unit 102 at a frame rate double the input frame rate (step S103), and generates the first and second sub-frame images F[i] and F[i+1] (step S104). Although the first and second sub-frame images are the same, one may be an interpolation image of the other one, as described above.

The bright/dark image generation unit 103 multiplies each of the R, G, and B levels of the first sub-frame F[i] by the gain value Gα, generating a bright image A[i] (step S105). Further, the bright/dark image generation unit 103 multiplies each of the R, G, and B levels of the second sub-frame F[i+1] by the gain value Gβ, generating a dark image B[i+1] (step S106). Note that the Gβ value is equal to or smaller than the Gα value. Note that bright and dark images can also be generated by multiplying the luminance value Y of a sub-frame by a gain value or looking up a lookup table.

The frequency distribution unit 104 removes a low-frequency component from the bright image A[i], generating a high-frequency image H[i] (step S107). In addition, the frequency distribution unit 104 extracts a low-frequency component from the dark image B[i+1], generating a low-frequency image L[i+1] (step S108). As described above, these processes are performed using the low-pass filter in accordance with equations (1) and (2). After that, the selection unit 105 alternately selects the high-frequency image H[i] and the low-frequency image L[i+1] at a sub-frame rate double the frame rate, outputs them to a monitor, and displays them.

As described above, according to this embodiment, an input frame image is replicated to generate a plurality of sub-frame images, and at least either of the brightness and spatial frequency component of at least part of the first sub-frame image out of the sub-frame images is changed to be different from that of the second sub-frame image. According to this embodiment, while reducing the unnaturalness of a motion, a decrease in luminance and a flicker can be suppressed. That is, sub-frames are displayed with a brightness difference, the spatial high-frequency component of the image is emphasized in the bright image, the spatial high-frequency component of the image is attenuated in the dark image, and these images are output to reduce a motion blur.

In this embodiment, the bright/dark image generation unit 103 and the frequency distribution unit 104 perform image processes on sub-frames. More specifically, the bright/dark image generation unit 103 adjusts the brightness of at least either of the first and second sub-frame images so that the brightness of the first sub-frame image becomes higher than that of the second sub-frame image. Further, the frequency distribution unit 104 adjusts the spatial frequency component of at least either of the first and second sub-frame images so that the spatial frequency component of the first sub-frame image is distributed in a frequency band higher than the spatial frequency component of the second sub-frame image. In this manner, as for an image having a motion, while increasing the brightness, the distribution of the spatial frequency component is adjusted. As a result, the naturalness of the motion and maintenance of the brightness of the image can be achieved.

Although the arrangement according to the above-described embodiment can reduce a motion blur, the high-frequency portion of an image is excessively emphasized in some cases. This is because the emphasis amount ((A[i]−LPF(A[i])) in equation (2)) of the high-frequency image H[i] and the attenuation amount ((B[i+1]−LPF(B[i+1])) in equation (1)) are sometimes different. For example, assuming that the input is a still image (F[i]=F[i+1]) for simplicity, the integrated value of the two sub-frames can be given by:

2×A[i]−LPF(A[i])+LPF(B[i]) (3)

where Fα=1 and Fβ=1.

A region having no high-frequency component, which is formed from the same image level though it depends on the filter characteristic, can be given by LPF(A[i])=A[i] and LPF(B[i])=B[i]. Expression (3) is equal to (A[i]+B[i]). In this case, the high-frequency portion of an image is neither excessively emphasized nor attenuated. In each region having a high-frequency component, the high-frequency component is calculated and emphasized/attenuated, so expression (3) may not coincide with (A[i]+B[i]). Another embodiment of the present invention will explain an example of an arrangement in which when emphasizing or attenuating a high-frequency component in a bright or dark image, it is prevented not to excessively emphasize or attenuate the high-frequency portion of the image.

### Image Display Apparatus

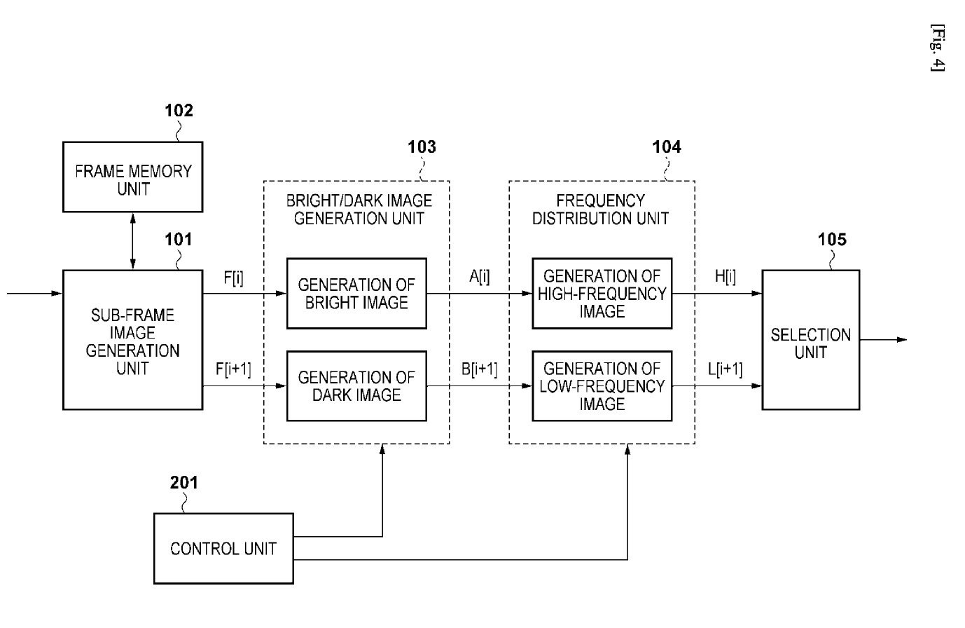

FIG. 4 is a block diagram showing an example of the functional arrangement of an image display apparatus according to this embodiment. The same reference numerals as those in the block diagram shown in FIG. 1 denote the same functional components, and a description thereof will not be repeated. A control unit 201 sets gain values Gα and Gβ in a bright/dark image generation unit 103, and coefficients Fα and Fβ in a frequency distribution unit 104.

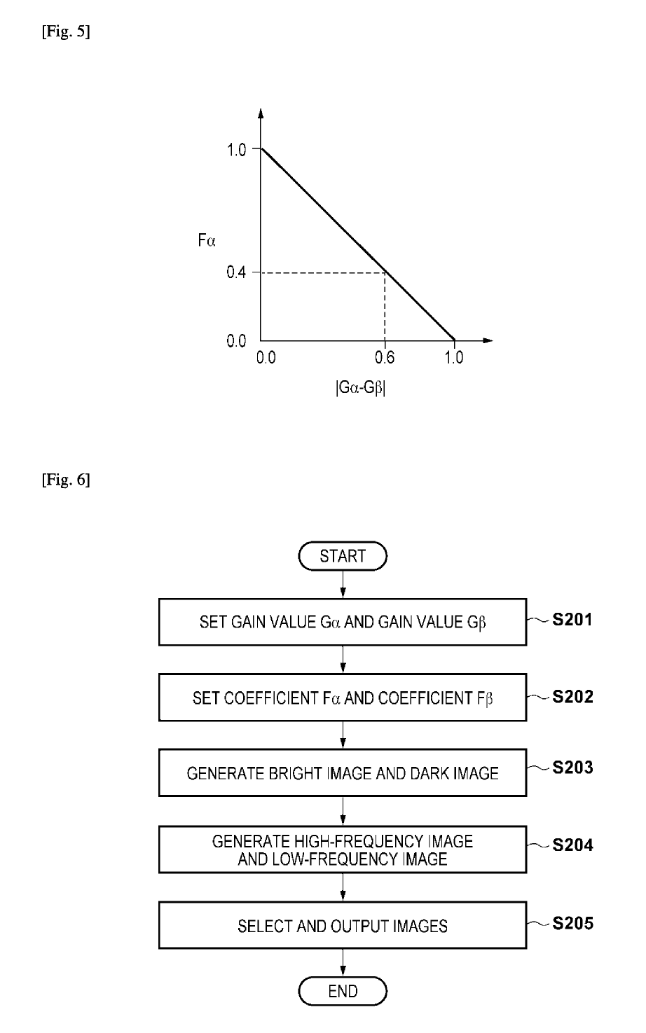

In addition to the difference value between the gain values Gα and Gβ, the control unit 201 variably controls, based on, for example, an example of the parameter setting shown in FIG. 5, the coefficients Fα and Fβ for adjusting the degrees of emphasis and attenuation of a high-frequency component. FIG. 5 is a graph showing an example of the parameter setting according to this embodiment. The abscissa represents the difference value between the gain values Gα and Gβ, and the ordinate represents the coefficients Fα and Fβ for adjusting the degrees of emphasis and attenuation of a high-frequency component set in accordance with the difference value. In the example of FIG. 5, both the coefficients Fα and Fβ are common (Fα=Fβ).

For example, in the case of black insertion, the gain value Gα is 100% (1.0), the gain value Gβ is 0% (0.0), and the difference value (|Gα−Gβ|)=1.0. At this time, both the coefficients Fα and Fβ are 0.0, and neither emphasis nor attenuation of a high-frequency component is performed (see equations (1) and (2)). To the contrary, when neither a bright image nor a dark image is generated, that is, both the gain values Gα and Gβ are 100% (1.0), the difference value (|Gα−Gβ|)=0.0. At this time, both the coefficients Fα and Fβ become 1.0, and emphasis and attenuation of a high-frequency component are performed. For example, when the gain value Gα is 80% (0.8) and the gain value Gβ is 20% (0.2), the difference value (|Gα−Gβ|)=0.6. At this time, 0.4 is set for the coefficients Fα and Fβ based on FIG. 5, the emphasis amount of the high-frequency component is set to be 40% for a high-frequency image H[i], and the attenuation amount is set to be 40% for a low-frequency image L[i+1].

Referring to FIG. 5 described above, for example, when a motion blur is reduced by black insertion, only black insertion can be applied (both the coefficients Fα and Fβ are set to be 0.0) not to excessively emphasize or attenuate the high-frequency portion.

When no brightness difference is set between sub-frames, neither a decrease in luminance nor a flicker is visually recognized, but the motion blur reduction effect is lost. In this case, a motion blur is reduced by performing emphasis and attenuation of a high-frequency component between sub-frames by the spatial frequency separation method (setting both the coefficients Fα and Fβ to be 1.0). Since bright and dark images have the same gain value, a phenomenon in which especially the high-frequency portion of a still image is strongly emphasized or attenuated is hardly visually recognized.

In contrast, when the bright and dark images take intermediate gain values, the degrees of emphasis and attenuation of a high-frequency component can be adjusted in accordance with the difference between the gain values of the bright and dark images. Although the degree of adjustment is not limited to one in FIG. 5, it is desirable to decrease the degrees of emphasis and attenuation of a high-frequency component as the difference (brightness difference) between the gain values of the bright and dark images is relatively large. The user may adjust the gain values of the bright and dark images as parameters for adjusting the degree of reduction of a motion blur or a parameter for adjusting the degree of a flicker. For example, a sub-frame image generation unit 101 estimates the presence/absence of a motion between successively input frames, and increases the difference between the gain values of bright and dark images for a region or frame for which it is estimated that there is a motion between frames or a motion is large. To the contrary, the sub-frame image generation unit 101 decreases the difference between the gain values of bright and dark images for a region or frame for which it is estimated that there is no motion between frames or a motion is small. Hence, a motion blur is reduced at a portion having a motion, and a flicker is reduced at a portion having no motion. Even if the estimation result is erroneous, a motion blur can be reduced by the spatial frequency separation method. In accordance with the presence/absence of a motion between frame images, a selection unit 105 may determine a sub-frame to be output. Thus, the balance between reduction of a motion blur and maintenance of the luminance can be adjusted appropriately.

### Processing Procedures

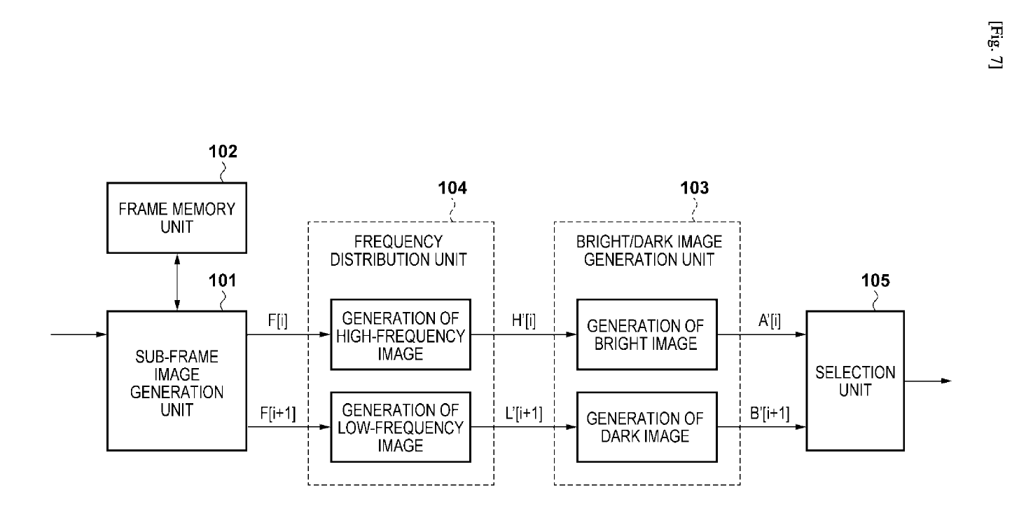

An example of processing procedures by the image display apparatus according to this embodiment will be explained with reference to FIG. 6. FIG. 6 is a flowchart showing the processing procedures according to this embodiment.

First, a gain value Gα for a first sub-frame image F[i] and a gain value Gβ for a second sub-frame image F[i+1] are set (step S201). Each gain value may be determined in accordance with a value adjusted by the user as a parameter for adjusting the degree of reduction of a motion blur, or may be calculated in accordance with the presence/absence or magnitude of a motion between frames, as described above.

Then, coefficients Fα and Fβ for adjusting the degrees of emphasis and attenuation of a high-frequency component are determined and set (step S202). The coefficients Fα and Fβ are determined based on, for example, FIG. 5 described above. After that, a bright image A[i] and a dark image B[i+1] are calculated (step S203). For example, the bright image A[i] has a value obtained by multiplying each of R, G, and B of the first sub-frame image F[i] by the gain value Gα. The dark image B[i+1] has a value obtained by multiplying each of R, G, and B of the second sub-frame image F[i+1] by the gain value Gβ.

The high-frequency image H[i] and the low-frequency image L[i+1] are calculated (step S204). The high-frequency image H[i] is an image in which the high-frequency component of an image is emphasized in the bright image A[i]. The high-frequency image H[i] is calculated based on, for example, equation (2). The low-frequency image L[i+1] is an image in which the high-frequency component of an image is attenuated in the dark image B[i+1]. The low-frequency image L[i+1] is calculated based on, for example, equation (1). Finally, the high-frequency image H[i] and the low-frequency image L[i+1] are selected and output in the order named (step S205).

In this embodiment, when emphasizing and attenuating the high-frequency components of bright and dark images, the coefficients Fα and Fβ for adjusting the degrees of emphasis and attenuation of a high-frequency component are determined in accordance with the gain values Gα and Gβ each representing the degree of adjustment of the brightness. More specifically, the spatial frequency component is adjusted to decrease the difference between the distributions of the spatial frequency components of the first and second sub-frame images as the brightness difference between the first and second sub-frame images for which the brightness is adjusted is relatively large. This can reduce excessive emphasis or attenuation of the high-frequency portion of an image. Note that the gain values Gα and Gβ and the coefficients Fα and Fβ may be set for each region in every frame.

### Functional Arrangement of Image Display Apparatus

FIG. 7 is a block diagram showing an example of the functional arrangement of an image display apparatus according to still another embodiment of the present invention. The same reference numerals as those in the block diagram shown in FIG. 1 denote the same functional components, and a description thereof will not be repeated. The processing order of a bright/dark image generation unit 103 and a frequency distribution unit 104 is opposite to that in the arrangement of FIG. 1. After a high-frequency image H′[i] is generated for a first sub-frame image F[i], a bright image A′[i] is generated. After a low-frequency image L′[i+1] is generated for a second sub-frame image F[i+1], a dark image B′[i+1] is generated.

Even in this embodiment, as in the arrangement of FIG. 1, a motion blur can be reduced by the spatial frequency separation method and by displaying sub-frames with a brightness difference. When a control unit (not shown) is arranged, coefficients Fα and Fβ for adjusting the degrees of emphasis and attenuation of a high-frequency component are determined in accordance with gain values Gα and Gβ, as in the arrangement of FIG. 4. This can reduce excessive emphasis or attenuation of the high-frequency portion of an image.

### Processing Procedures

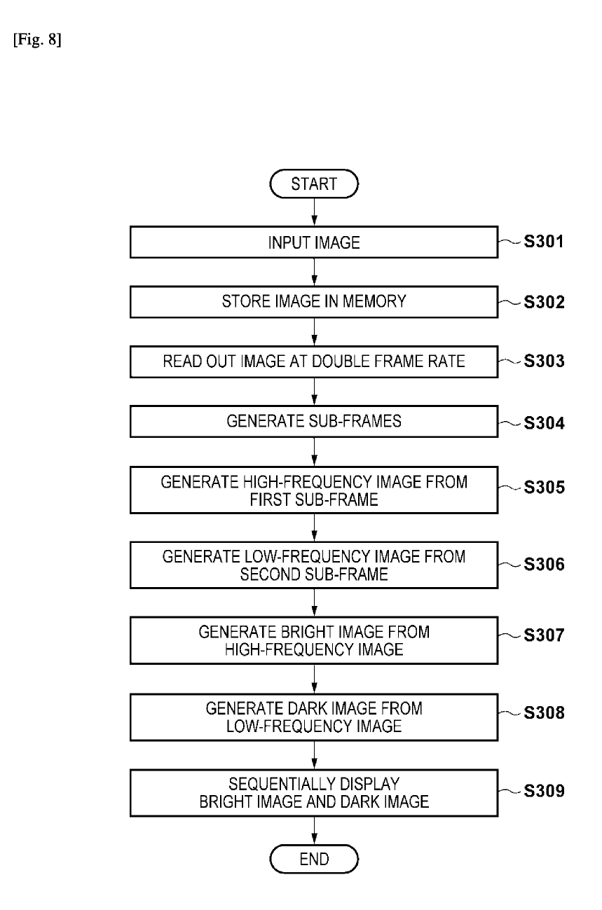

Next, a series of processes to be executed by the image display apparatus according to this embodiment will be explained with reference to FIG. 8. FIG. 8 is a flowchart showing the processing procedures of processing to be executed by the image display apparatus according to this embodiment.

Processes in steps S301 to S304 are the same as those in steps S101 to S104 of FIG. 3, and a description thereof will not be repeated. After generating first and second sub-frames F[i] and F[i+1] in step S304, the frequency distribution unit 104 removes a low-frequency component from the first sub-frame F[i], generating a high-frequency image H′[i] (step S305). Further, the frequency distribution unit 104 extracts a low-frequency component from the second sub-frame F[i+1], generating a low-frequency image L′[i+1] (step S306). As described above, these processes are performed using the low-pass filter in accordance with equations (1) and (2).

Then, the bright/dark image generation unit 103 multiplies each of the R, G, and B levels of the high-frequency image H′[i] by the gain value Gα, generating a bright image A′[i] (step S307). Further, the bright/dark image generation unit 103 multiplies each of the R, G, and B levels of the low-frequency image U[i+1] by the gain value Gβ, generating a dark image B[i+1] (step S308). Note that the Gβ value is equal to or smaller than the Gα value. Note that bright and dark images can also be generated by multiplying the luminance value Y of a sub-frame by a gain value or looking up a lookup table. A selection unit 105 alternately selects the bright image A′[i] and the dark image B′[i+1] at a sub-frame rate double the frame rate, outputs them to a monitor, and displays them.

As described above, after frequency distribution is performed for each sub-frame image, brightness adjustment is performed, and sub-frames are output at a high frame rate corresponding to the number of replicated sub-frames. Even in this case, reduction of a motion blur and maintenance of the luminance can be achieved.

According to each of the above-described embodiments, while reducing a motion blur, a decrease in luminance and an increase in flicker can be suppressed.

The present invention can provide a technique capable of suppressing a decrease in luminance and an increase in flicker while reducing the unnaturalness of a motion.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-213981, filed on Oct. 20, 2014, which is hereby incorporated by reference herein in its entirety.

1. An image processing apparatus comprising:
(a) an input unit configured to input a frame image;
(b) a generation unit configured to generate a plurality of sub-frame images from the frame image input by the input unit;
(c) an image processing unit configured to change a brightness and spatial frequency component of a first sub-frame image out of the plurality of sub-frame images to be different from a brightness and spatial frequency component of a second sub-frame image out of the plurality of sub-frame images; and
(d) an output unit configured to output the first sub-frame image and the second sub-frame image.

2. The image processing apparatus according to claim 1, wherein the image processing unit further comprises:
a brightness adjustment unit configured to adjust the brightness of at least one of the first sub-frame image and the second sub-frame image so as to set the brightness of the first sub-frame image to be higher than the brightness of the second sub-frame image; and
a frequency distribution unit configured to adjust the spatial frequency component of at least one of the first sub-frame image and the second sub-frame image so as to distribute the spatial frequency component of the first sub-frame image in a frequency band higher than the spatial frequency component of the second sub-frame image.

3. The image processing apparatus according to claim 2, wherein the frequency distribution unit adjusts the spatial frequency component of at least one of the first sub-frame image and the second sub-frame image at a degree corresponding to a degree of adjustment of the brightness of at least one of the first sub-frame image and the second sub-frame image in the brightness adjustment unit.

4. The image processing apparatus according to claim 3, wherein the frequency distribution unit adjusts the spatial frequency component to decrease a difference between a distribution of the spatial frequency component of the first sub-frame image and a distribution of the spatial frequency component of the second sub-frame image as a brightness difference between the first sub-frame image and the second sub-frame image for which the brightness adjustment unit adjusts the brightness is relatively large.

5. The image processing apparatus according to claim 1, wherein the image processing unit further comprises:
a dark image generation unit configured to generate a dark image in which the brightness of at least part of the first sub-frame image is reduced; and
a low-frequency image generation unit configured to generate a low-frequency image in which a high-frequency component of the dark image is attenuated.

6. The image processing apparatus according to claim 5, wherein the low-frequency image generation unit attenuates the high-frequency component of the dark image at a degree corresponding to a degree of adjustment of the brightness of the first sub-frame image in the dark image generation unit.

7. The image processing apparatus according to claim 1, wherein the image processing unit further comprises:
a bright image generation unit configured to generate a bright image in which the brightness of at least part of the first sub-frame image is increased; and
a high-frequency image generation unit configured to generate a high-frequency image in which a high-frequency component of the bright image is emphasized.

8. The image processing apparatus according to claim 7, wherein the high-frequency image generation unit emphasizes the high-frequency component of the bright image at a degree corresponding to a degree of adjustment of the brightness of the first sub-frame image in the bright image generation unit.

9. The image processing apparatus according to claim 1, wherein the image processing unit further comprises:
a low-frequency image generation unit configured to generate a low-frequency image in which a high-frequency component of the first sub-frame image is attenuated; and
a dark image generation unit configured to generate a dark image in which the brightness of at least part of the low-frequency image is reduced.

10. The image processing apparatus according to claim 1, wherein the image processing unit further comprises:
a high-frequency image generation unit configured to generate a high-frequency image in which a high-frequency component of the first sub-frame image is emphasized; and
a bright image generation unit configured to generate a bright image in which the brightness of at least part of the high-frequency image is increased.

11. The image processing apparatus according to claim 1, wherein the input unit successively inputs a plurality of frame images, and
wherein the image processing unit adjusts the brightness of a sub-frame image at a degree corresponding to presence/absence of a motion between the frame images.

12. The image processing apparatus according to claim 1, wherein the input unit successively inputs a plurality of frame images, and
wherein the output unit determines a sub-frame to be output in accordance with presence/absence of a motion between the frame images.

13. The image processing apparatus according to claim 1, wherein the input unit successively inputs a plurality of frame images at a predetermined frame rate,
wherein the generation unit generates N sub-frame images for one frame image, and
wherein the output unit outputs the sub-frame image at a rate N times higher than the frame rate.

14. An image display apparatus comprising:
(a) an image processing apparatus; and
(b) a display unit configured to display a sub-frame image output from an output unit,
wherein the image processing apparatus comprises:
(i) an input unit configured to input a frame image;
(ii) a generation unit configured to generate a plurality of sub-frame images from the frame image input by the input unit;
(iii) an image processing unit configured to change a brightness and spatial frequency component of a first sub-frame image out of the plurality of sub-frame images to be different from a brightness and spatial frequency component of a second sub-frame image out of the plurality of sub-frame images; and
(iv) an output unit configured to output the first sub-frame image and the second sub-frame image.

15. A control method for an image processing apparatus, the control method comprising:
an input step of causing an input unit to input a frame image;
a generation step of causing a generation unit to generate a plurality of sub-frame images from the frame image input in the input step;
an image processing step of causing an image processing unit to change a brightness and spatial frequency component of a first sub-frame image out of the plurality of sub-frame images to be different from a brightness and spatial frequency component of a second sub-frame image out of the plurality of sub-frame images; and
an output step of causing an output unit to output the first sub-frame image and the second sub-frame image.

16. A non-transitory computer-readable storage medium storing a computer program for causing a computer to function as each unit of an image processing apparatus comprising:
(a) an input unit configured to input a frame image;
(b) a generation unit configured to generate a plurality of sub-frame images from the frame image input by the input unit;
(c) an image processing unit configured to change a brightness and spatial frequency component of a first sub-frame image out of the plurality of sub-frame images to be different from a brightness and spatial frequency component of a second sub-frame image out of the plurality of sub-frame images; and
(d) an output unit configured to output the first sub-frame image and the second sub-frame image.
